(19) United States
(12) Patent Application Publication
(10) Pub. No.: US 2014/0137460 A1
(43) Pub. Date: May 22, 2014

(54) FISHING DEVICE

(71) Applicant: Eugene R. Weber, Appleton, WI (US)

(72) Inventor: Eugene R. Weber, Appleton, WI (US)

(21) Appl. No.: 14/078,704

(22) Filed: Nov. 13, 2013

Related U.S. Application Data
(63) Continuation-in-part of application No. 12/940,656, filed on Nov. 5, 2010.
(60) Provisional application No. 61/258,358, filed on Nov. 5, 2009.

(51) Int. Cl. A01K 97/10

(52) U.S. Cl. CPC A01K 97/10
USPC 43/21.2

(57) ABSTRACT

A fishing rod holder that is foldable into a compact form, and includes an indicator to show a strike by a fish. The holder has a base with a first lock plate and a second lock plate, a first support having a first lock member, and a second support having a second lock member. The first and second supports are connected to the base such that the first and second supports may be rotated with respect to the base between an open position and a closed position. An indicator is attached to one support and to fishing line such that when the fishing line is pulled away from the reel, the indicator is changed from a first position with respect to the post to a second position with respect to the post.

### CROSS REFERENCE TO RELATED APPLICATIONS

This application is a continuation in part of U.S. patent application Ser. No. 12/940,656, filed Nov. 5, 2010, which patent application is incorporated herein by reference in its entirety. This application also claims the benefit of U.S. Provisional Patent Application Ser. No. 61/258,358, filed Nov. 5, 2009, the disclosure of which is hereby incorporated by reference herein in its entirety for all purposes.

### FIELD OF THE INVENTION

The present invention relates generally to the field of fishing. More specifically the invention relates to a portable rod holder with a visual strike indicator.

### BACKGROUND OF THE INVENTION

Although portable rod holders and strike indicators are known in the prior art, these types of portable rod holders have not been fully optimized. One example of prior art portable rod holders and strike indicators is described in U.S. Pat. No. 6,427,376 by the inventor of the present invention which is hereby incorporated by reference herein in its entirety for all purposes. The inventor has improved on several dimensions of the prior art in this field.

For example, one problem with certain prior art devices is that the means for locking open the rod supports adds an additional movable part with additional hinges. The addition of moveable parts decreases the simplicity of the apparatus and increases the likelihood of failure such as, for example, if the hinges freeze or if dirt prevents the hinges from fully opening or closing. The addition of another part and hinges increases the weight, bulk, cost and complexity of manufacture of the apparatus.

Another problem with certain prior art devices is that there is no means for preventing over-extension of the rod supports when opened such as by rotating the rod supports past ninety degrees or from the strike of a large fish. This increases the likelihood of hinge failure. If the hinges fail, the rod holder will be inoperable.

Another problem with certain prior art devices is that there is no easily visible identification of when a fish bites or is hooked on the fishing line. This inconveniences an angler because it requires the angler to check the fishing rod and holder to see if there is a fish on the line. Worse yet, there are times when a fish takes only the bait without biting the hook or when initially on the hook, manages to get off the hook. Therefore, a prudent angler without the convenience of a visible indicator would need to pull the line out of the water to ensure the bait is still on the line multiple times throughout the day.

As such, there is a need for a portable rod holder that provides a means for locking the rod holder in an open position with as little extra parts, especially movable parts, as possible, while maintaining a compact closed profile. It is similarly desirable to prevent over rotation of the rod supports. It is also desirable to provide for an easy to see strike indicator that is easy to attach to the fishing line. The inventors have improved on these and other aspects of the various prior art devices in this field.

### SUMMARY OF THE INVENTION

The invention provides a fishing rod holder, having a base with a first lock plate and a second lock plate, a first support having a first lock member, and a second support having a second lock member. The first and second supports are connected to the base such that the first and second supports may be rotated with respect to the base. The first and second lock members are selectively engagable with the first and second lock plates respectively. The first support has an opening such that the second lock member is selectively engagable with the opening. The first and second supports can be rotated with respect to the base between an open position and a closed position such that the first and second lock members are engaged with the first and second lock plates respectively when the first and second supports are in the open position and the first and second lock members are disengaged from the first and second lock plates respectively when the first and second supports are in the closed position. The first support has an opening that engages with the second lock member when the first and second supports are in the closed position. The first support, second support and base have generally the same width. When the first and second supports are moved to the closed position, the second support substantially lies on the base and the first support substantially lies on the second support. The first and second lock plates prevent the first and second supports from rotating beyond a predetermined angle with respect to the base. An indicator is attached to one support and to fishing line such that when the fishing line is pulled away from the reel, the indicator is changed from a first position with respect to the post to a second position with respect to the post.

Other objects and advantages of the invention will become apparent hereinafter.

### BRIEF DESCRIPTION OF THE DRAWINGS

FIG. 1 is a side elevation view of the fishing rod holder in accordance with the invention in use with a fishing rod.

FIG. 2 is an isometric view of the fishing rod holder in an open position in accordance with the invention.

FIG. 3 is an enlarged partial isometric view of the fishing rod holder shown in FIG. 1 showing the rear support in a locked open position.

FIG. 4 is an enlarged partial isometric view of the fishing rod holder shown in FIG. 1 showing the operation of unlocking of the rear support so that it may be closed.

FIG. 5 is an isometric view of the fishing rod holder of FIG. 1 showing the rear support in a closed position.

FIG. 6 is a an enlarged partial isometric view of the fishing rod holder shown in FIG. 1 showing the operation of unlocking of the front support so that it may be closed.

FIG. 7 is an isometric view of the fishing rod holder from FIG. 1 in a mostly collapsed and unlocked position.

FIG. 8 is an isometric view of the fishing rod holder from FIG. 7 in a completely closed and locked position.

FIG. 9 is an enlarged partial isometric view of the fishing rod holder shown in FIG. 1 showing the strike indicator.

FIG. 10 is a cross-sectional view of the fishing rod holder shown in FIG. 9, taken along the lines 10-10, showing the strike indicator.

FIG. 11 is an isometric view of the rear of the strike indicator from FIG. 9.

### DETAILED DESCRIPTION

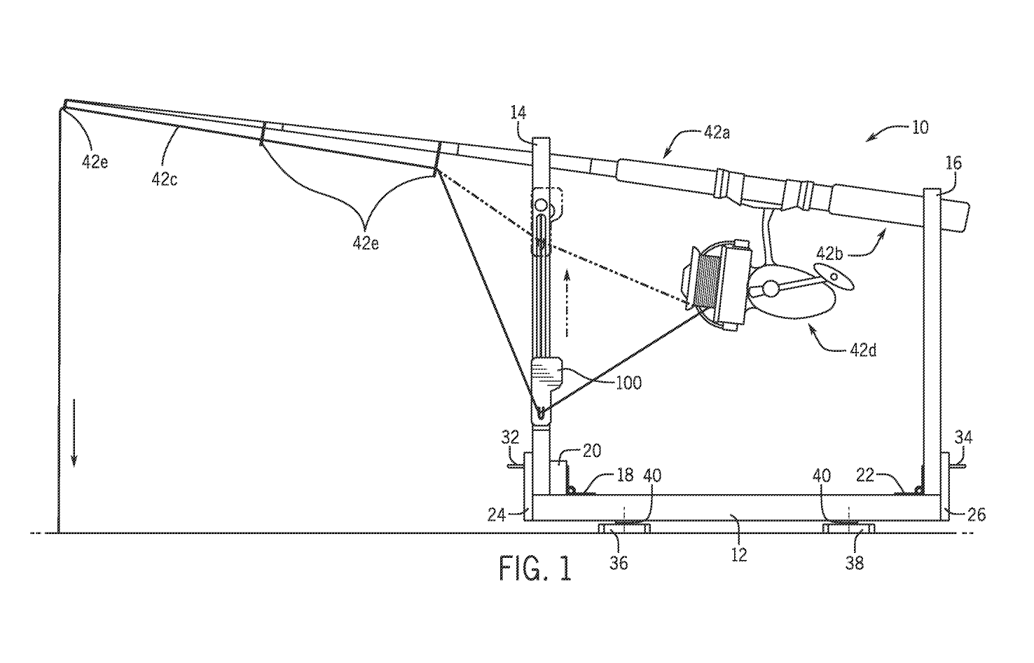

The fishing rod holder 10 of the present invention has a platform and at least one post, rod arm or support. Referring to the figures, the fishing rod holder 10 includes a base 12, front support 14 and a rear support 16. The bottom of the front support 14 is connected to the front of the base 12 by a hinge 18. As seen in FIG. 1, the front support 14 has a spacer block 20 between it and the hinge 18 to offset it for reasons discussed further below. The bottom of the rear support 16 is connected to the rear of the base 12 by a hinge 22. The hinges 18, 22 permit the supports 14, 16 to be folded down.

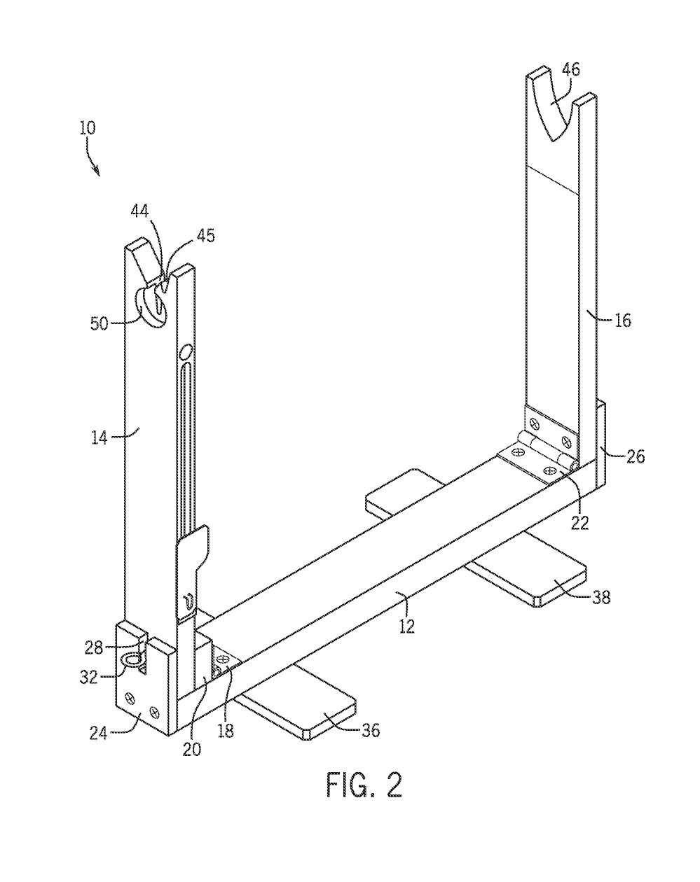

As seen in FIG. 2, a front lock plate 24 or block is connected to or integrally formed with the front facing end of the base 12, generally perpendicularly. The front support 14 is connected by spacer block 20 and hinge 18 to base 12 such that when the front support 14 is fully opened, the front face of the front support 14 will contact a first, or front, block or lock plate 24. Similarly, at the rear facing end of the base 12, a second, or rear, block or lock plate 26 is connected or integrally formed generally perpendicularly thereto. The rear support 16 is connected by the hinge 22 to the base 12 such that when the rear support 16 is fully opened, the rear face of the rear support will contact the rear lock plate 26. The front lock plate 24 and the rear lock plate 26 thereby respectively prevent the front support 14 and rear support 16 from being over-rotated or unfolded and damaging the hinges 18, 22, respectively. However, other rotating or folding limiting methods may be used without departing from the spirit of the invention.

In one embodiment, the front lock plate 24 has an opening 28 and rear lock plate 26 has an opening 30. The front support 14 has a first locking member 32 on its front face. A second locking member 34 is located on the rear face of the rear support 16. Although each of the first locking member 32 and second locking member 34 are shown as eyebolts or screw eyes that are rotatably mounted to the supports, other suitable locking elements are known in the industry and may be used without departing from the spirit of the invention.

When the supports 14, 16 are opened, they can be held open by the first and second locking members 32, 34 respectively. In the embodiment shown in FIG. 2, the locking members 32, 34 are positioned and oriented such that they at least partially fit through the openings 28, 30 in the supports 14, 16. For example, when the front support 14 is opened, a portion of the locking member 32 may fit into the opening 28 of the front lock plate 24. Similarly, when the rear support 16 is opened, a portion of the locking member 34 may fit into the opening 30 of the front lock plate 24. The openings 28, 30 are sized, oriented and/or shaped such that the locking members 32, 34 may fit into and out of the openings 28, 30 respectively in a first orientation (such as seen in FIGS. 4 and 6-7) and held by the openings 28, 30 respectively (as seen in FIGS. 2-3 and 5) when the locking members 32, 34 are in a second orientation.

For example, in FIG. 2, the opening 28 is shown as a slot through the front lock plate 24. The locking member 32, shown as an eyebolt, fits into and out of the opening 28 when the eyebolt is oriented the same as the slotted opening 28. Once through the slotted opening 28, the eyebolt may be rotated such that the eyebolt can no longer fit through the slotted opening 28, generally about ninety degrees. Thereby, the front support 14 and rear support 16 are held in their open positions as seen in FIG. 2.

A first, or front, foot 36 and a second, or rear, foot 38 are generally flat members that are attached to the bottom of the base 12 in such a way that the feet 36, 38 can be rotated between a deployed position generally perpendicular to the base 12 (FIGS. 2-7) and a stowed position generally parallel to the base (FIG. 8). As seen in FIG. 1, the feet 36, 38 have two washers 40 separating the feet 36, 38 from the base 12 to provide smooth rotating of each of the first 36 and second foot 38 and to prevent wear. One of the two washers 40 may be a curved spring washer. Other means of connecting each of the two feet 36, 38 to the base are known in the industry and can be used without departing from the spirit of the invention. With at least one of the two feet 36, 38 in a deployed position, the fishing rod holder 10 is more stable and less likely to tip to one side or the other.

When the fishing rod holder 10 is unfolded, a fishing rod 42 may be held thereby, an example of which can be seen in FIG. 1. At the top of the front support 14 is an opening 45, shown in FIG. 2, sized and/or shaped such that the butt 42a of a fishing rod 42 may be positioned in the opening 45 by a user. Similarly, the rear support 16 has an opening 46 sized and/or shaped such that the handle 42b of a fishing rod 42 may be positioned in the opening 46 by a user. The fishing rod 42 could also be placed in the fishing rod holder 10 in the opposite configuration wherein the handle 42b sits in the top of slot 44 and the butt 42a sits in the opening 46. In this arrangement, the handle 42b of the fishing rod 42 is further off the ground and easier to pick up when a fish is on the line or adjustment is desired.

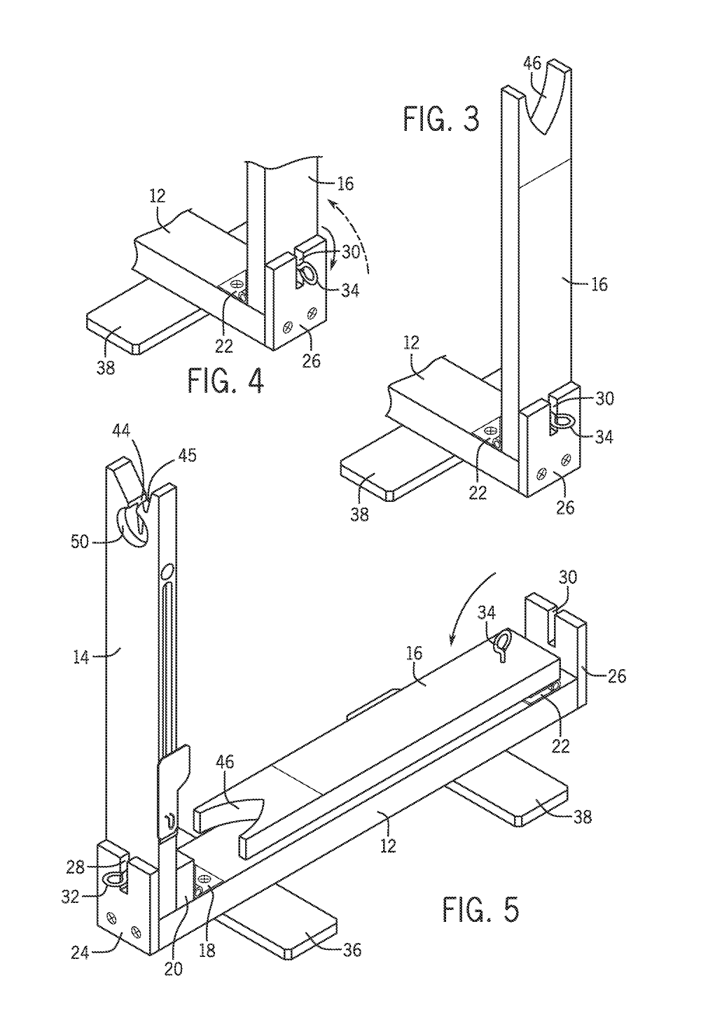

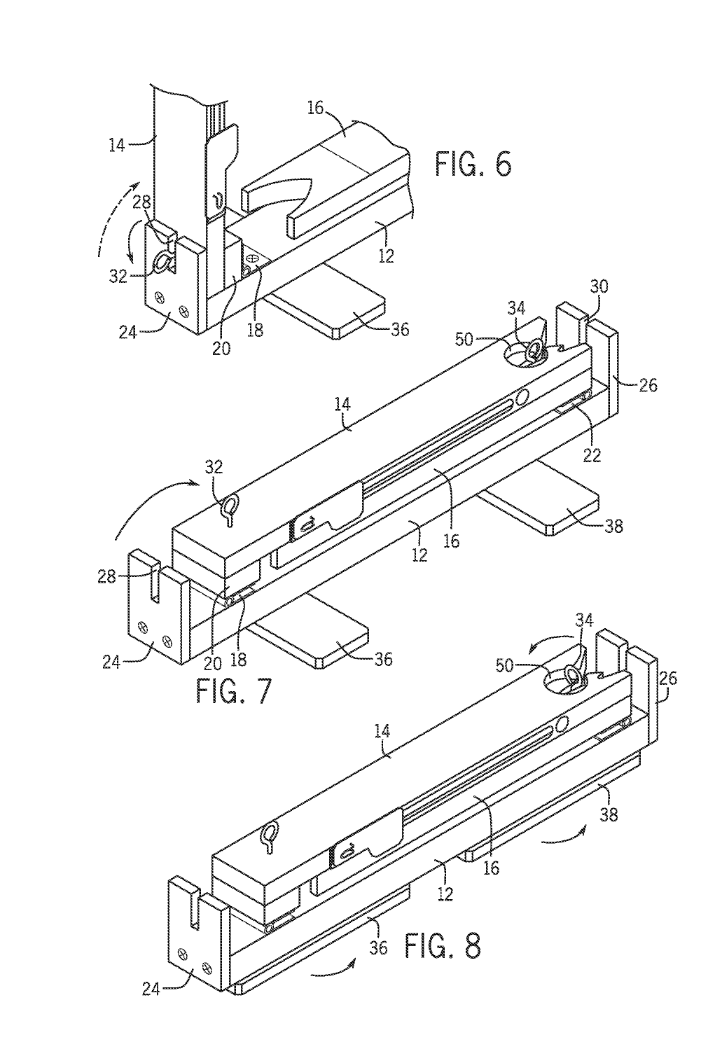

The fishing rod holder 10 may also be closed such as for compact travel or storage. To close the fishing rod holder 10, the rear locking member 34 must be unlocked as seen by comparing FIGS. 3 and 4. Once the rear locking member 34 is unlocked, the rear support 16 may be folded down onto the base 12 as shown in FIG. 5. The front locking member 32 must also be unlocked as seen in FIG. 6. Once the front locking member 32 is unlocked, the front support 14 may be folded down onto the rear support 16 shown in FIG. 7. As can be seen by comparing FIGS. 6 and 7, the spacer block 20, between the front support 14 and the hinge18, is about the same thickness as the rear support 16. Thus the spacer block 20 permits the front support 14 to fold down compactly and substantially onto the rear support 16. Once the feet 36, 38 are rotated to their stowed positions, as seen in FIG. 8, the holder is in a completely closed position where it is compact and has a small profile.

To lock the fishing rod holder 10 in the closed position, the front support 14 may have an opening 50. The opening 50 is sized, oriented and/or shaped such that the rear locking member 34 may fit into and out of the opening 50 in one orientation (such as seen in FIG. 7) and when the rear locking member 34 is in another orientation, the locking member 34 is prevented from going through the opening 50 (as seen in FIG. 8). For example, in FIG. 5, the opening 50 is seen as a slot 44 through the front support 14 that is countersunk on the front face of the front support 14. In the embodiment shown, the rear locking member 34 is an eyebolt that fits into and out of the opening 50 when it is oriented the same as the slotted opening 50 as seen in FIG. 7. Once through the slotted opening 50, the eyebolt may be rotated such that the eyebolt can no longer fit through the slotted opening 50 as seen in FIG. 8, generally about ninety degrees. When the fishing rod holder 10 is locked in the closed position, the front support 14 prevents the fishing rod holder 10 from inadvertently opening.

Although the fishing rod holder 10 discussed above is generally shown as being made from wood, the fishing rod holder 10 could be made from other materials, such as plastic, without departing from the spirit of the invention. As such, the fishing rod holder 10 described herein is inexpensive to manufacture.

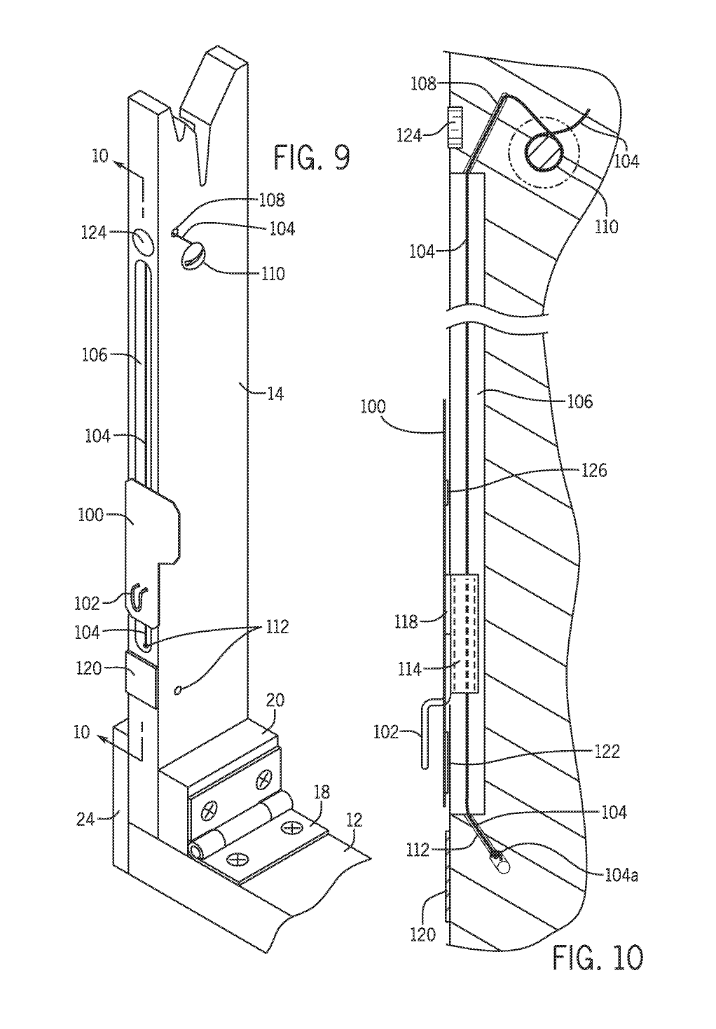

The front support 14 may also have a strike indicator 100, which can be made of plastic, although it could also be made from other materials without departing from the spirit of the invention. The strike indicator 100 seen in FIG. 9 includes a hook 102. The fishing line 42c from the reel 42d of the fishing rod 42 is placed in the hook 102 between the reel and the start of the ferrules or eyelets 42e on the fishing rod 42 as seen in FIG. 1. When a fish bites or strikes the lure in the water and begins to move with the lure, the fishing line becomes taut, and that increase in the tension of the fishing line pulls the strike indicator upward as seen by the dashed lines in FIG. 1. In the example shown, the strike indicator moves from a first position, at the bottom of the front support 14, to a second position at the top of the front support. Thus, an angler may see from a distance that the lure was struck by a fish when the strike indicator 100 is in the up position. The strike indicator may also be of a bright color, such as blaze orange, so as to be more readily noticeable from a distance.

In one embodiment, the strike indicator 100 is attached to the fishing rod holder 10 by a slide, although other means of securing the strike indicator are known in the industry and may be used without departing from the spirit of the invention. In the embodiment shown in FIGS. 9 and 10, the strike indicator 100 is slidably attached to a side of the front support 14, such as by a string 104, which can be made of various materials including fishing line, attached to the front support 14. As shown there, the string runs through at least one tube 114 attached to the back of the strike indicator 100. Other slide means are known in the industry, e.g. metal wire or a cord, and may be used without departing from the spirit of the invention. However, the use of fishing line is convenient because it is presumed that if the string 104 needs to be changed, e.g. from breakage, an angler will have more fishing line available from which to replace the string.

The side of the front support 14 has a groove 106 that runs generally parallel to the front support 14. A section of the string 104 runs at least partially inside the groove 106. As shown in FIG. 9, the string 104 is anchored at or near the bottom of the groove 106 in a hole 112 provided for that purpose. The hole 112 has a smaller diameter at the groove 106 and a larger diameter at the face of the front support 14. The bottom of the string 104 is held in place by a knot 104a in the string 104 that is small enough to fit in the larger diameter of the hole 112, but large enough so as not to fit inside the smaller diameter of the hole 112. From there, the string 104 extends upward and exits the top of groove 106 by a hole 108 on the rear face of the front support 14, where the string 104 is held in place by suitable means. Various means of securing the string 104 are known in the industry, such as a tension adjusting member, and may be used without departing from the spirit of the invention. However, in the embodiment shown in FIGS. 9 and 10, the top end of the string is wrapped around a screw 110, which has the advantage of being capable of being used to adjust the tension of the string 104 in the field so as to allow the strike indicator 100 to freely move up the front support 14.

In the embodiment shown in FIGS. 9-11, the hook 102 is U-shaped, and the top legs of the U-shape extend through the strike indicator 100 and up the back face of the strike indicator 100. The hook 102 can be affixed to the back face of the strike indicator 100 by any suitable means such as glue. A tube 114 is then also attached to the back face of the strike indicator 100. In order to keep the axis of the tube 114 parallel to the string 104, a spacer 118 is optionally placed between the back face of the strike indicator 100 and the tube 114. The string 104 runs through the tube 114 such that the strike indicator may be pulled up the front support 14 during a fish strike or returned back down once the fish has been removed from the lure and the fishing rod 42 is reset. More than one tube 114 or pipe may be used without departing from the spirit of the invention.

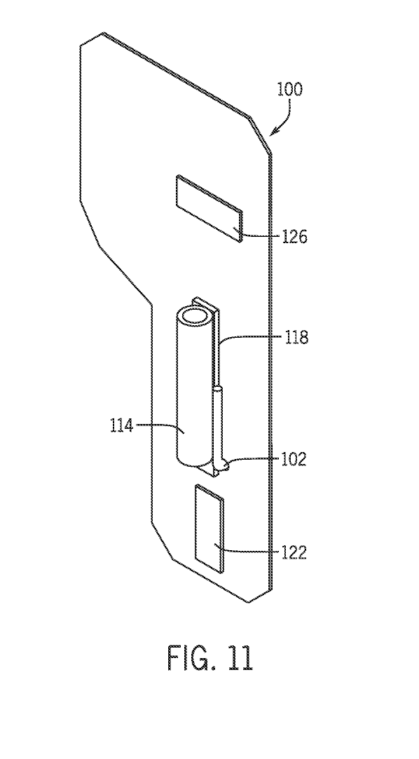

In order to prevent false strikes, such as the wind blowing on the fishing line or something contacting, but not biting, the lure, a lower magnet 120 that is relatively weak is attached to the bottom of the side of the front support 14, below the groove 106, as seen in FIG. 10. A first magnetic piece 122 is secured to the bottom of the back face of the strike indicator 100, as seen in FIG. 11, such that when the strike indicator is at the bottom of the groove 106, the first magnet 120 cooperates with the first magnetic piece 122, thereby temporarily holding the strike indicator 100 at the bottom of the front support 14 until a strike, thus preventing false strikes.

A second magnet 124 is attached to the top of the side of the front support 14, above the groove 106, as seen in FIGS. 9 and 10. The second magnet 124 is preferably stronger than the first magnet 120. A second magnetic piece 126 is secured to the top of the back face of the strike indicator 100, as seen in FIG. 11, such that when the a fish strikes and the strike indicator reaches the top of the groove 106, the second magnet 124 cooperates with the second magnetic piece 126 thereby holding the strike indicator 100 at the top of the front support 14. Holding the strike indicator 100 at the top of the groove 106 even after a fish is no longer on the line is desirable because it indicates that the fishing rod 42 may need attention such as when a fish takes the bait off the hook, but does not bite the hook, or if the fish breaks the fishing line. Other means of holding the strike indicator 100 at the top and/or bottom of the groove 106 are known in the industry and may be used without departing from the spirit of the invention.

The cooperation of the first magnet 120 and the first magnetic piece 122 on the strike indicator may also be used to set the depth of the bait below the surface of the water without needing to use a float or bobber. Floats and bobbers can become clogged or iced up at the surface of the water depending on the temperature of the air. Also, floats and bobbers are located at or slightly below the surface of the water within the ice hole and as such are recessed below the surface of the ice, making visibility compromised from any significant distance when ice fishing. The bobbers and floats may also impede the ability of the angler to reel in the line, as most of these devices clamp or are otherwise attached to the line.

The cooperation of the first magnet 120 and the first magnetic piece 122 permit the depth of the bait to be set without the need for a bobber or float. The desired amount of fishing line is let out from the reel and the bait is placed in the water. With the fishing rod 42 in the fishing rod holder 10, the strike indicator 100 would normally be positioned at the bottom of the groove 106 and held at that position by attraction of the first magnet 120 and the first magnetic piece 122. The angler would then put the fishing line in the hook 102 of the strike indicator 100. This will hold the bait at the desired depth without need for a bobber or float. Because the indicator described above is not fixed to the fishing line and because the fishing rod holder allows for use without a bobber or float, the fishing line may be fully retrieved, such as, for example, when finished fishing. However, the fishing rod holder described herein could also be used with bobbers or floats and can be used for shallow or deep water applications, inside or outside of shelter.

The amount of force required to pull the first magnetic piece 122 of the strike indicator 100 from the first magnet 120 can be adjusted based upon the application of the fishing rod holder 10. For example, larger bait or target fish may require a stronger magnetic attraction and smaller bait or target fish may work better with a lighter magnetic attraction. If a stronger magnetic attraction is desired, the first magnetic piece 122 of the strike indicator 100 can be positioned along the front support 14 such that the entire first magnetic piece 122 is connected to the first magnet 120. Alternatively, if a lighter magnetic attraction is desired, the first magnetic piece 122 of the strike indicator 100 can be positioned along the front support 14 such that it is barely attracted to the first magnet 120. In an alternate embodiment, the strength of the first 120 and/or second magnets 124 could be adjusted as necessary for the particular bait used or fish sought.

The first 120 and/or second magnets 124 may also be used as a lure holder during set up of the fishing rod 42 in the fishing rod holder 10 because most hooks used in fishing are made of ferrous material. Alternatively, a hook, eye, loop, staple, or some other mechanical fastener may be used to hold lures.

One advantage of the fishing rod holder 10 described above is that it will work with virtually any conventional fishing rod and reel. Further, to the extent a specific configuration is necessary, the fishing rod holder 10 described above can be easily adapted to fit such a configuration. For example, the distance between the front 14 and rear supports 16 can be adjusted by adjusting the length of the base 12. The height of the front 14 and rear supports 16 can be adjusted, as can the openings 44, 45 and 46 for the fishing rod. The fishing rod holder 10 can also be sized such that when it is unfolded or locked in its open position, it will be too large to fall into an ice fishing hole, accidentally or otherwise.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A fishing rod holder comprising:
a base with a first lock plate and a second lock plate;
a first support having a first lock member;
a second support having a second lock member,
the first and second supports connected to the base such that the first and second supports may be rotated with respect to the base; and
the first and second lock members selectively engagable with the first and second lock plates respectively.

2. The fishing rod holder of claim 1 wherein the first support has an opening such that the second lock member is selectively engagable with the opening.

3. The fishing rod holder of claim 1 wherein the first and second supports can be rotated with respect to the base between an open position and a closed position such that the first and second lock members are engaged with the first and second lock plates respectively when the first and second supports are in the open position and the first and second lock members are disengaged from the first and second lock plates respectively when the first and second supports are in the closed position.

4. The fishing rod holder of claim 3 wherein the first support has an opening that engages with the second lock member when the first and second supports are in the closed position.

5. The fishing rod holder of claim 4 wherein the first support, second support and base have generally the same width.

6. The fishing rod holder of claim 3 wherein when the first and second supports are in the closed position, the second support substantially lies on the base and the first support substantially lies on the second support.

7. The fishing rod holder of claim 1 wherein the first and second lock plates prevent the first and second supports from rotating beyond a predetermined angle with respect to the base.

8. The fishing rod holder of claim 1 wherein:
each of the first and second lock members is an eyebolt; and
each of the first and second lock plates has an opening such that the eyebolts may at least partially fit through when the eyebolts are in a first orientation and the eyebolts may not fit through when the eyebolts are in a second orientation.

9. The fishing rod holder of claim 1 wherein each of the first and second supports is adapted to support a fishing rod.

10. The fishing rod holder of claim 1 wherein each of the first and second supports are connected to the base by a hinge.

11. The fishing rod holder of claim 10 further comprising a first foot and a second foot, each connected to the base such that each of the first foot and the second foot can be rotated with respect to the base.

12. A fishing rod holder holding a fishing rod with a reel and fishing line, the fishing rod holder comprising:
a base;
at least one post connected to the base such that the at least one post may be rotated with respect to the base; and
an indicator attached to the at least one post and to the fishing line such that when the fishing line is pulled away from the reel, the indicator may be changed from a first position with respect to the at least one post to a second position with respect to the at least one post.

13. The fishing rod holder of claim 12 wherein a magnet is attached to the at least one post and a magnetic piece is attached to the indicator such that when the indicator is changed to the second position, the magnet cooperates with the magnetic piece to hold the indicator at the second position.

14. The fishing rod holder of claim 12 wherein a magnet is attached to the at least one post and a magnetic piece is attached to the indicator such that the magnet cooperates with the magnetic piece to temporarily hold the indicator at the first position.

15. The fishing rod holder of claim 12 wherein the indicator is attached to the at least one post by a cord.

16. The fishing rod holder of claim 15 wherein the at least one post has a groove and the cord is located at least partially within the groove.

17. The fishing rod holder of claim 15 wherein the indicator has a tube through which the cord runs such that the indicator may slide along the cord.

18. The fishing rod holder of claim 15 further comprising a tension adjusting member that is connected to the cord such that the tension adjusting member may adjust the tension of the cord.

19. The fishing rod holder of claim 12 wherein the indicator has a hook and the fishing line is attached to the indicator by the hook.

20. A fishing rod holder comprising:
a platform with a front and a rear;
a rear lock block with an opening connected to the rear of the platform substantially perpendicular to the platform;
a front lock block with an opening connected to the front of the platform substantially perpendicular to the platform;
a rear rod arm with a rear lock member, the rear rod arm connected to the rear of the platform by a hinge such that the rear rod arm can be moved between a closed position in which the rear rod arm lies substantially on top of the platform and an open position in which the rear rod arm is substantially perpendicular to the platform;
a front rod arm comprising:
a front lock member;
an opening; and
a groove;
the front rod arm connected to the front of the platform by a hinge and offset from the hinge by a spacer block such that the front rod arm can be moved between a closed position in which the front rod arm lies substantially on top of the rear rod arm and an open position in which the front rod arm is substantially perpendicular to the platform;
the front lock member capable of connecting to the front lock block when the front rod arm is in the open position;
the rear lock member capable of connecting to the rear lock block when the rear rod arm is in the open position and capable of connecting to the opening of the front rod arm when the rear rod arm is in the open position;
a string in the groove of the front rod arm;
an indicator with a pipe wherein the string runs through the pipe such that the indicator can slide along the front rod arm; and
at least two feet connected to the platform such that each of the two feet can be rotated with respect to the platform.
